(19) United States
(12) Patent Application Publication
(10) Pub. No.: US 2003/0070502 A1
(43) Pub. Date: Apr. 17, 2003

(54) Twin-link robotic arm

(76) Inventors: Tommy Douglas Brett, Mississauga (CA); Iain Michael Andrew Hendry, Innerkip (CA); Matthew Gordon Davidson, Guelph (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/244,753

(22) Filed: Sep. 17, 2002

Related U.S. Application Data
(60) Provisional application No. 60/329,337, filed on Oct. 16, 2001.

(51) Int. Cl. B25J 18/00

(52) U.S. Cl. 74/490.01; 901/14

(57) ABSTRACT

A twin link robotic arm has first and second arm links and a grounded first rotation synchronization member. The first arm link is rotatable relative to the grounded first rotation synchronization member about a first axis of rotation. The second arm link is rotatably mounted to the first arm link and is rotatable relative to the first arm link about a second axis of rotation. A second rotation synchronization member is provided on the second arm link. The second rotation synchronization member is non-rotatably fixed relative to the second arm link and is rotatable relative to the first arm link about the second axis of rotation. A rotation synchronizing coupler connects the first rotation synchronization member to the second rotation synchronization member and drives rotation of the second arm link relative to the first arm link about the second axis of rotation when the first arm link is rotated about the first axis of rotation.

The present application claims priority from U.S. provisional patent application No. 60/329,337 filed on Oct. 16, 2001.

### FIELD OF THE INVENTION

The present invention relates generally to robots and more particularly to robotic arms.

### BACKGROUND OF THE INVENTION

Robots such as robotic arms have numerous industrial applications. One application is in the plastic injection moulding industry which is faced with the problem of removing moulded components from moulding machines.

At each moulding cycle, single or multiple components are ejected from the open mould. These components are either allowed to fall into a collection chute or, more commonly, they are manually removed from the open mould.

In order to improve production efficiency and worker safety it is desirable to employ robotic devices to perform the component removal task. A robotic arm can be many times quicker in removing the components and far more reliable than a human worker. The human worker can now be removed from close proximity to the potentially hazardous moulding machine.

The plastic injection moulding industry typically employs three axis linear robotic arms to remove injected components from the mould. These robotic arms are relatively slow moving, have coarse motion and tend to be expensive to produce due to the extensive number of linear components required. For example, it is common to use a servomotor coupled to an individual gear reducer for each of the three axes.

Rails are typically used to guide the motion of the robotic arm along each axis. In order to ensure smooth and reliable movement, bearings are used in the rails. The proper installation of the bearings and alignment of the rails is a time consuming and troublesome task and adds substantial cost to a three axis linear robotic arm.

In addition to the significant cost associated with such robotic arms, the use of rails results in inherent speed and acceleration limitations.

Accordingly, it is desirable to provide a robotic arm capable of increased speed and finer motion while being available at reduced cost.

### SUMMARY OF THE INVENTION

The present invention provides a robotic arm capable of quick, controlled motion within a three axis work envelope using only two servo axes in a compact package. The robotic arm is suitable for direct mounting to the platen of an injection-moulding machine.

It is an object of the present invention to obviate or mitigate at least one disadvantage of previous robotic arm applications for pick and place applications.

According to a first aspect of the present invention, there is provided a robotic arm, comprising: a grounded first rotation synchronization member; a first arm link rotatable relative to the grounded first rotation synchronization member about a first axis of rotation; a second arm link rotatably mounted to the first arm link, the second arm link rotatable relative to the first arm link about a second axis of rotation; a second rotation synchronization member provided on the second arm link, the second rotation synchronization member being nonrotatably fixed relative to the second arm link and rotatable relative to the first arm link about the second axis of rotation; and a rotation synchronizing coupler connecting the first rotation synchronization member to the second rotation synchronization member, the rotation synchronization coupler for driving rotation of the second arm link relative to the first arm link about the second axis of rotation when the first arm link is rotated about the first axis of rotation.

For example, in a first embodiment of the present invention, a robotic arm has a twin link design in which a servomotor causes rotation of two rotary joints causing a payload to travel in an arcuate path.

A robotic arm according to the present invention achieves a desired movement of a payload (such as removing a component from a moulding machine) using only two servomotors rather than the three servomotors used by a conventional three axis robotic arm. The robotic arm of the present invention also does not require the costly and troublesome use of linear axes.

According to a second aspect of the present invention, there is provided a robotic arm, comprising: a grounded first rotation synchronization member; a first arm link rotatable relative to the grounded first rotation synchronization member about a first axis of rotation; a second arm link rotatably mounted to the first arm link, the second arm link rotatable relative to the first arm link about a second axis of rotation; a second rotation synchronization member provided on the second arm link, the second rotation synchronization member being non-rotatably fixed relative to the second arm link and rotatable relative to the first arm link about the second axis of rotation; a first rotation synchronizing coupler connecting the first rotation synchronization member to the second rotation synchronization member, the first rotation synchronization coupler for driving rotation of the second arm link relative to the first arm link about the second axis of rotation when the first arm link is rotated about the first axis of rotation; a third rotation synchronization member provided on the second arm link, the third rotation synchronization member being non-rotatably fixed relative to the second arm link; a payload mounting element rotatably mounted to the second arm link, the payload mounting element rotatable relative to the second arm link about a third axis of rotation; a fourth rotation synchronization member provided on the second arm link, the fourth rotation synchronization member being non-rotatably fixed relative to the payload mounting element and rotatable relative to the second arm link and; a second rotation synchronizing coupler connecting the third rotation synchronization member to the fourth rotation synchronization member, the second rotation synchronizing coupler for driving rotation of the payload mounting element relative to the second arm link about the third axis when the second arm link is rotated about the second axis of rotation.

For example, in a second embodiment of the present invention, a robotic arm has a twin link design in which a servomotor causes rotation of three rotary joints causing a payload to travel in a linear path and maintain a fixed orientation with respect to world coordinates.

The linear motion achieved by the present invention enables the robotic arm to extract components with minimal clearance. In addition, the inherent speed and acceleration limitations caused by the use of rails in side entry linear robotic devices used for part retrieval are not present. Instead, the twin link jointed design of the present invention has rotary joints that allow the use of, for example, rotary bearings which enable the invention to operate at higher speeds. Typically, when rotary bearings are used they are not the speed limiting factor.

Advantageously, a robotic arm of the present invention is able to move a payload located at the end of the second arm link in a linear path, while maintaining a fixed attitude with respect to world coordinates. Other useful paths and orientations of the payload can be achieved by varying the diameters of the rotation synchronization members.

A robotic arm according to the present invention is particularly suited to side entry applications in the injection moulding and blow moulding industries. Because the arm links overlap, the total reach capability of the mechanism is twice the sum of the distances between the axes of rotation of each arm link. When both arm links are in line with each other (arm links retracted), a minimal spatial envelope is apparent. The ratio of reach envelope to robotic arm footprint envelope is typically 10:1. This feature is particularly useful where long reach is needed, yet floor space between obstructions (e.g. the space between adjacent injection moulding machines) is at a premium.

The arrangement of the present invention is such that equal performance can be achieved regardless of the direction of rotation of the first arm link rotation. This allows the user to select the direction of arm link crossover without the need to change the design. This feature is useful to avoid obstructions. The concept also allows for continuous unidirectional rotation of the drive motor, which provides an oscillating linear motion of the payload with a natural, mechanically induced sinusoidal velocity profile. This motion gives extremely smooth directional changes.

The twin-link, three-joint mechanism allows for extremely fast motion of a payload held by a payload mounting member such as an end effector at the free end of the second arm link since the speed of the free end of the second arm link is compounded by the swing radius of the first rotary joint.

The twin-link, three-joint concept, in common with the twin-link two-joint design provides smooth, controlled motion due to inherent mechanically induced natural acceleration and deceleration ramps.

Other aspects and features of the present invention will become apparent to those ordinarily skilled in the art, upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an elevated perspective view of a first embodiment of a robotic arm according to the invention;

FIG. 2 is a elevation view of the robotic arm of FIG. 1;

FIG. 3 is a plan view of the robotic arm of FIG. 1

FIG. 4 is a plan view of an alternative embodiment of a robotic arm according to the present invention ; and

FIG. 5 is an elevation view of the robotic arm of FIG. 4 illustrating movement of the robotic arm.

### DETAILED DESCRIPTION

According to a first embodiment of the present invention, a robotic arm has a twin link design in which a servomotor causes rotation of two rotary joints causing a payload to travel in an arcuate path.

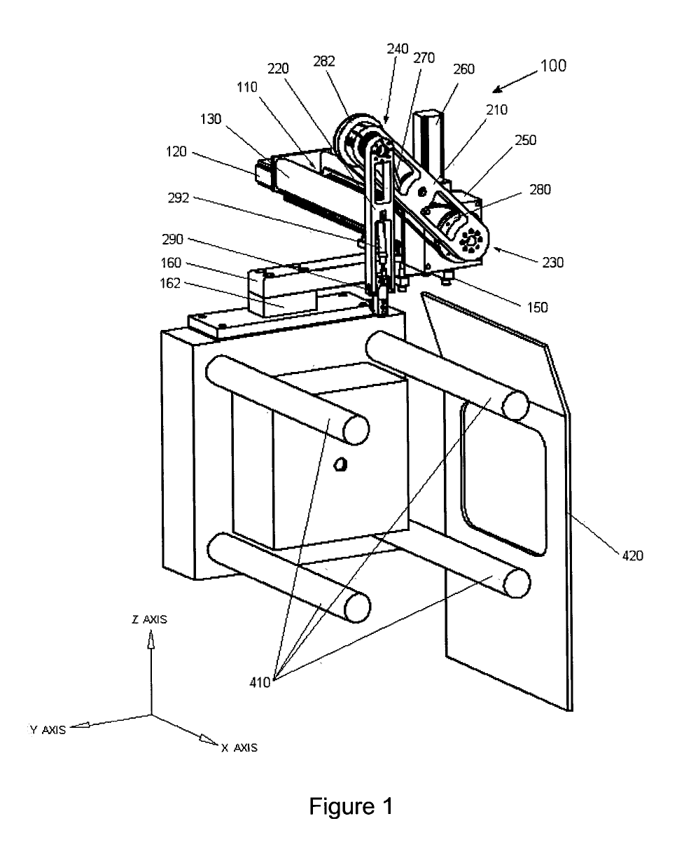

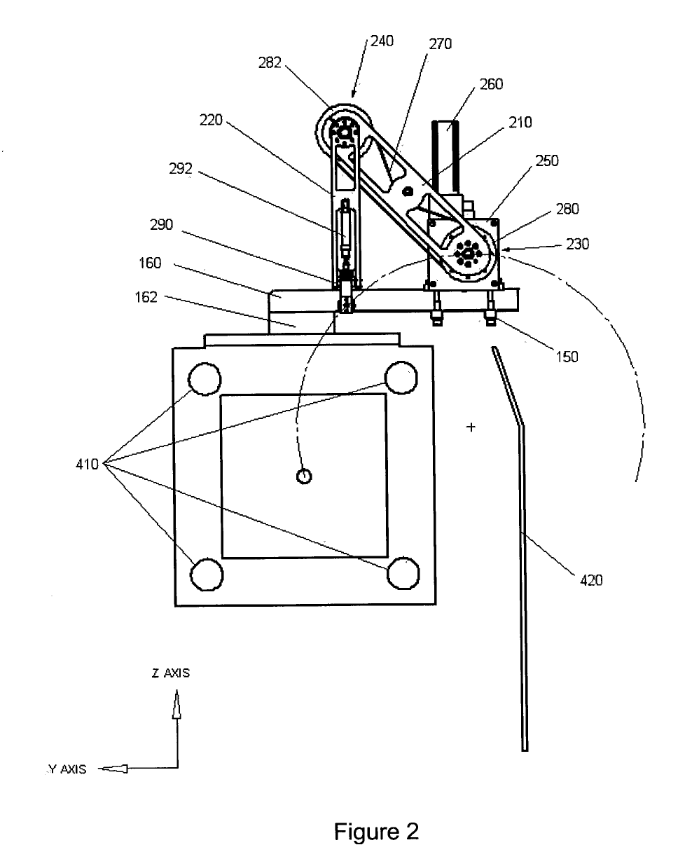

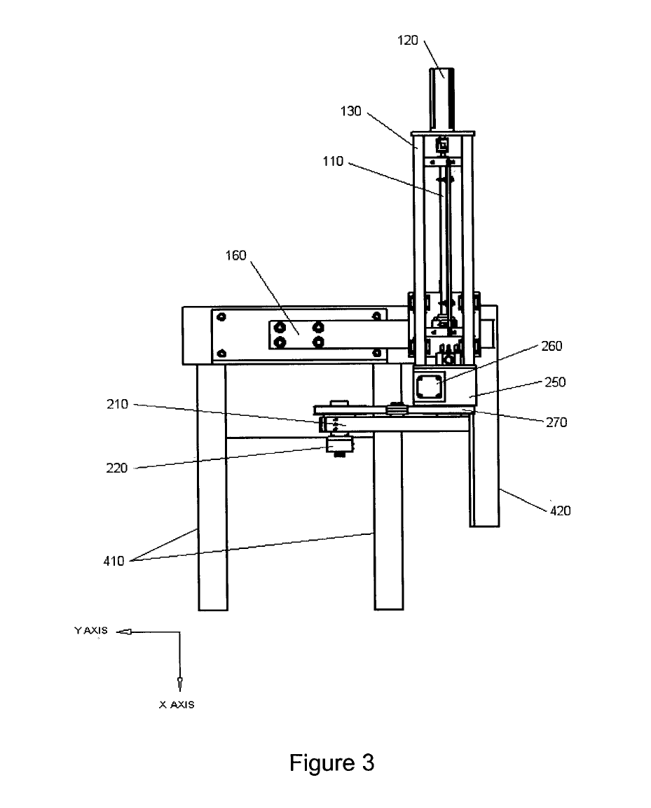

Referring to FIGS. 1, 2 and 3, robotic arm 100 has two axes providing three degrees of co-ordinated motion. Independent motion in the X direction is provided, for example, by a linear ball screw mechanism 110, directly driven by a motor such as a first electric servomotor 120. The servomotor 120 rotates the screw to effect linear motion of the X module 130 in the X direction preferably by reacting against a stationary mating ball nut (not shown).

Mounted to the front of the X module 130 is a robotic arm comprising a first arm link 210 and a second arm link 220, linked by a first rotary joint 230 and second rotary joint 240. The first rotary joint 230 is mounted to a drive shaft. For example, the first rotary joint 230 is preferably mounted directly to, for example, a low-backlash worm and wheel gearbox 250, which in turn is mounted to the X module 130. A motor such as an electrical servomotor 260 drives the first rotary joint 230 via the worm and wheel gearbox 250. The first rotary joint 230 causes the first arm link 210 to rotate about the axis of rotation of the first rotary joint 230.

The second link arm 220 is linked to the first arm link 210 via the second rotary joint 240. Rotation of the second arm link 220 is effected by a rotation synchronization coupler such as synchronizing belt 270 connecting the first rotary joint 230 and second rotary joint 240. The synchronizing belt 270 preferably passes over a first rotation synchronization member, such as first pulley 280, and a second rotation synchronization member, such as second pulley 282, to cause the first arm link 210 and the second arm link 220 to move synchronously. The first pulley 280 is fixed (in the present example the first pulley 280 is fixed to the gearbox 250) causing the synchronizing belt 270 to rotate the second rotary joint 240 and the attached second arm link 220. More specifically, as the first arm link is rotated about the first axis of rotation, the fixed nature of the first rotation synchronization member creates a tension differential between the two portions of the belt on either side of the second rotation synchronization member resulting in a torque being applied to the second rotation synchronization member which in turn results in rotation of the second arm link about the second axis of rotation. Preferably, the first and second pulleys 280, 282 and the synchronizing belt 270 are toothed.

In the present example, the first pulley is fixed by attachment to the gearbox. Accordingly, the first pulley is fixed with respect to a local coordinate reference system which forms a suitable basis for describing the relative movements of the robotic arm links and payload. If the robotic arm is mounted on a vehicle, then the first pulley could also be fixed with respect to the vehicle directly (mounted to the vehicle) or indirectly (mounted to a secondary mount within the vehicle).

An important property of the arrangement of the robotic arm of the present invention is that the first rotation synchronization member, illustrated here by first pulley 280, be grounded. By “grounded” we mean fixed with respect to world coordinates. However, we also include the arrangement described above in which the first rotation synchronization member is fixed with respect to a relevant local coordinate reference system.

The ratio between the first and second pulley pitch diameters dictates the relative angular motion of the first and second link arms (210, 220). A pulley ratio of 1:1 causes the second arm link 220 to maintain a constant angle with respect to world coordinates, as the second arm link 220 rotates about the axis of the second rotary joint 240. Selection of suitable pulley ratios (for example, a ratio of 2:3 between the first and second pulley pitch diameters) can provide vertical insertion of the second link arm 220 into the moulding machine (partially illustrated in FIG. 1 by tie bars 410 and guarding means 420) and extend the second link arm 220 to a horizontal position outside of the moulding machine.

This action is particularly well suited to part picking, where there is a need to intrude rapidly into the mould opening to extract and then deposit the part at maximum distance from the moulding machine.

The second link arm 220 may be adjusted to ensure that it remains vertical (or any other pre-selected angle) throughout the complete range of travel of the robotic arm 100. This enables the robotic arm 100 to pick injection moulded components (not shown) from the moulding machine and transfer them to the side of the moulding machine using a path which avoids the moulding machine tie bars 410 or other obstructions of the moulding machine, such as guarding means 420.

A hand or end effector (not shown) is located at the free end of the second link arm 220. The end effector is attached using a wrist pitch joint 290.

The “twin-link” mechanism of the present embodiment inherently provides a sinusoidal velocity profile of the distal end of the second link arm 220 (where the end effector is located), which gives a smooth acceleration and deceleration to the work piece or payload held by the end effector at the end of the wrist pitch joint 290.

The wrist pitch joint 290 is preferably actuated by a pneumatic linear cylinder 292, providing 90 degrees of pitch rotation. The wrist pitch joint 290 is used for orientation of the moulded components subsequent to removal from the mould opening. Additional manipulation axes could be added to further improve dexterity. These could be fluid or electric powered.

The relative lengths of first arm link 210 and second arm link 220 can be varied to suit a particular application as required.

The “twin-link” design precludes the need for separate Y-axis and Z-axis motion. However, it is necessary to provide a means of adjusting the Y and Z positions of the X module 130, and this is achieved, for example, by a simple sliding clamp design 150.

The robotic arm 100 and pedestal 160 are designed for mounting to either side of any suitable moulding machine, without modification. Height adjustment is effected by varying the dimension of riser 162.

According to a second embodiment of the present invention, a robotic arm 600 has a twin link design in which a servomotor causes rotation of three rotary joints causing a payload to travel in a linear path.

This embodiment utilizes common components with the twin link, two jointed robotic arm 100 described in the previous embodiment, but with an additional synchronizing belt 671 driving a third rotary joint 643. All other descriptions of the previous twin-link, two-jointed arm embodiment apply to the present twin-link, three-jointed embodiment.

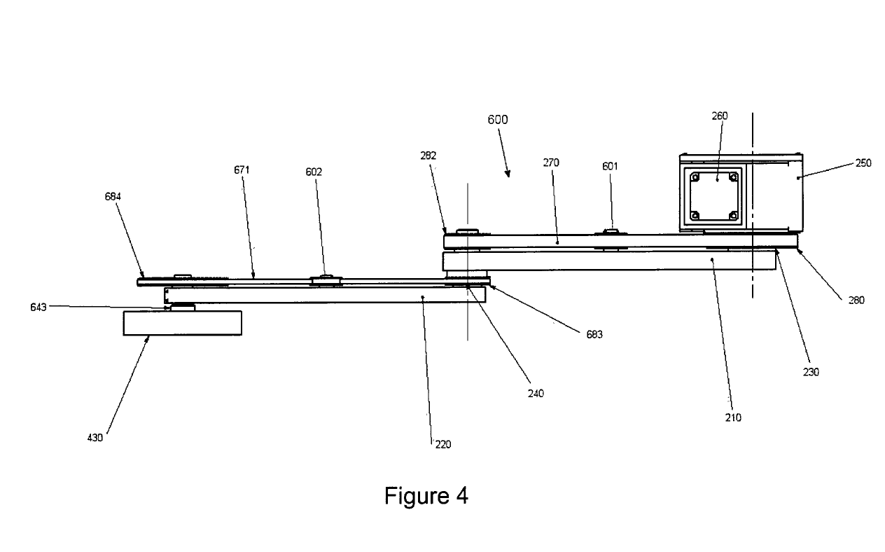

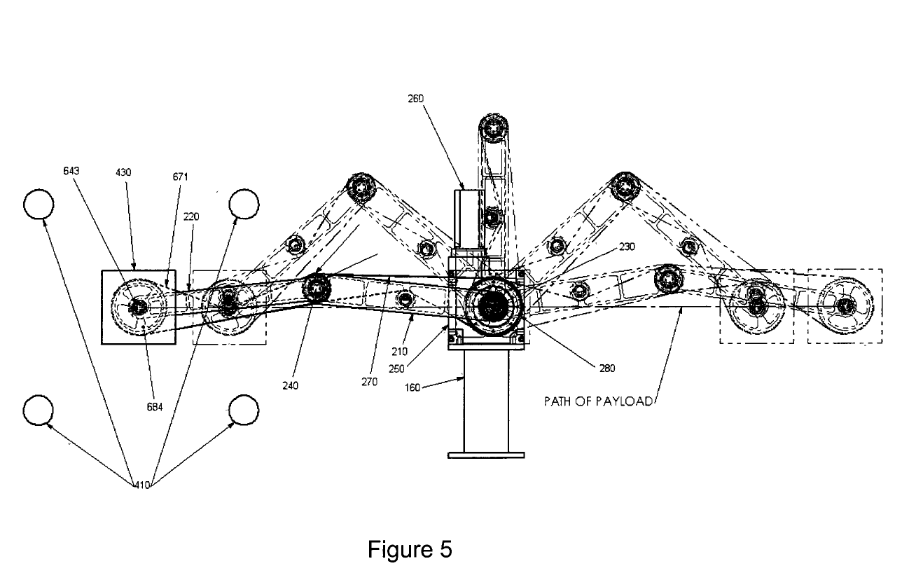

Referring to FIGS. 4 and 5, robotic arm 600 is similar to robotic arm 100 in that they both employ similar principles. Specifically, a pair of arm links are coupled and driven by synchronizing belts around rotatable joints to achieve specific combined linear and rotational motion to a third rotatable joint.

More specifically, in robotic arm 600, first arm link 210 is rotated about the axis of the first rotary joint 230 and is driven in a similar manner to the first invention, typically with a servomotor 260 driving through a gear reducer 250 and fixed (grounded) first pulley 280. A synchronizing toothed belt 270 driving a second pulley 282, which is fixed to the shaft of a second rotary joint 240, effects rotation of the second arm link 220. A third pulley 683, fixed to the same rotating shaft as second pulley 282, is interconnected to a fourth pulley 684 fixed to a shaft rotating at third rotary joint 643 at the far end of the second link arm 220. The payload (not shown) is fixed to the shaft of third rotary joint 643 by use of a payload mounting element 430 such as a hand or end effector or by any other suitable means.

As shown in FIG. 4, tension pulleys 601 and 602 are used to ensure adequate tension of the sychronizing belts 270 and 671 respectively.

FIG. 5 illustrates exemplary typical obstructions encountered in injection moulding machine applications such as tie bars 410.

FIG. 5 also illustrates a bi-directional rotation of the servomotor 260 to achieve a linear movement of the payload 430. The servomotor 260 reverses direction at the two extreme positions in which the robotic arm 600 is fully extended so that the robotic arm 600 follows a back-and-forth motion.

However, the robotic arm 600 is programmable via a controller (not shown) to operate in a different mode in which the servomotor 260 rotates continuously in the same direction. Thus the robotic arm 600 follows a rotary motion while providing the payload 430 with an oscillating linear motion having a natural, mechanically induced sinusoidal velocity profile. This motion has extremely smooth directional changes.

The ratio of pulley sets dictates the final motion profile of the payload 430 mounted to the end of the second link arm 220. To achieve true linear motion of the payload 430, the respective pulley sets 280, 282 and 683, 684 diameter ratios are 2:1 for joints 230 and 240 and 1:2 for joints 240 and 643. Other ratios may be selected which give specific nonlinear paths or payload orientations.

A floor-mounted pedestal 160 is typically employed for supporting the robotic device at the correct location for optimal reach performance. Other means of mounting could include direct attachment to a moulding machine or other machinery, as appropriate.

Although the present example has been given in the context of moulding machine applications, the present invention can be used for any applications requiring such motions, either for high speed or high payload capability.

Although this description does not mention an X-axis, it is apparent that this axis or any additional linear or rotational axis (axes) could be readily added to further increase reach envelope capability. These additional axes could be located upstream or downstream of the twin-link device.

In a further alternative embodiment, a robotic arm provides linear motion of the payload but not fixed orientation. According to this embodiment, a robotic arm comprises a first arm link, a second arm link rotatably connected to the first arm link, first and second rotation synchronization members such as toothed pulleys on respective arm links, the rotation synchronization members connected by a rotation synchronization coupler such as a toothed belt. A payload is held at the free end of the second arm link. This arrangement is similar to the second embodiment without the second rotation synchronization coupler and third and fourth rotation synchronization members.

Using a ratio of 2:1 for the first and second pulleys, the payload moves in a straight line while causing the payload to change angle with respect to world coordinates. For 90 degrees rotation of the first arm about the first axis of rotation, the payload is rotated 90 degrees with respect to world coordinates.

The descriptions here refer to robotic arms having the arm links moving in a vertical plane i.e. with the rotary axes in a horizontal plane. The orientation of the arm links could be in any plane as required to suit the application, for example, arm link move in a horizontal plane with the rotary axes in a vertical plane.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A robotic arm, comprising:
a grounded first rotation synchronization member;
a first arm link rotatable relative to the grounded first rotation synchronization member about a first axis of rotation;
a second arm link rotatably mounted to the first arm link, the second arm link rotatable relative to the first arm link about a second axis of rotation;
a second rotation synchronization member provided on the second arm link, the second rotation synchronization member being non-rotatably fixed relative to the second arm link and rotatable relative to the first arm link about the second axis of rotation; and
a rotation synchronizing coupler connecting the first rotation synchronization member to the second rotation synchronization member, the rotation synchronization coupler for driving rotation of the second arm link relative to the first arm link about the second axis of rotation when the first arm link is rotated about the first axis of rotation.

2. The robotic arm of claim 1, wherein the first and second rotation synchronization members are mounted concentrically with the first and second axes of rotation respectively.

3. The robotic arm of claim 1, wherein the robotic arm is mounted to a motor.

4. The robotic arm of claim 3, wherein the motor is a servomotor.

5. The robotic arm of claim 1, wherein the first rotation synchronization member comprises a fixed first pulley mounted concentrically with the first axis of rotation; the second rotation synchronization member comprises a second pulley rotatably mounted to the first arm link concentric with the second axis of rotation; and the rotation synchronization coupler comprising a synchronizing belt extending between the first and second pulleys.

6. The robotic arm of claim 6, wherein the synchronizing belt is toothed.

7. The robotic arm of claim 6, wherein the first and second pulleys are toothed.

8. The robotic arm of claim 5, wherein the ratio between the first and second pulley pitch diameters is 1:1.

9. The robotic arm of claim 1, wherein the second arm link maintains a constant angle, with respect to world coordinates, as the second arm link rotates about the first arm link.

10. The robotic arm of claim 1, wherein the second arm link changes angle, with respect to world coordinates, as the second arm link rotates about the first arm link.

11. The robotic arm of claim 10, wherein the second arm link changes from a vertical orientation, with respect to world coordinates to a horizontal orientation with respect to world coordinates, as the second arm link rotates about the first arm link.

12. The robotic arm of claim 11 wherein the ratio between the first and second pulley pitch diameters is 3:2.

13. A robotic arm, comprising:
a grounded first rotation synchronization member;
a first arm link rotatable relative to the grounded first rotation synchronization member about a first axis of rotation;
a second arm link rotatably mounted to the first arm link, the second arm link rotatable relative to the first arm link about a second axis of rotation;
a second rotation synchronization member provided on the second arm link, the second rotation synchronization member being non-rotatably fixed relative to the second arm link and rotatable relative to the first arm link about the second axis of rotation;
a first rotation synchronizing coupler connecting the first rotation synchronization member to the second rotation synchronization member, the first rotation synchronization coupler for driving rotation of the second arm link relative to the first arm link about the second axis of rotation when the first arm link is rotated about the first axis of rotation;
a third rotation synchronization member provided on the second arm link, the third rotation synchronization member being non-rotatably fixed relative to the second arm link;
a payload mounting element rotatably mounted to the second arm link, the payload mounting element rotatable relative to the second arm link about a third axis of rotation;
a fourth rotation synchronization member provided on the second arm link, the fourth rotation synchronization member being non-rotatably fixed relative to the payload mounting element and rotatable relative to the second arm link and;
a second rotation synchronizing coupler connecting the third rotation synchronization member to the fourth rotation synchronization member, the second rotation synchronizing coupler for driving rotation of the payload mounting element relative to the second arm link about the third axis when the second arm link is rotated about the second axis of rotation.

14. The robotic arm link of claim 13, wherein the first rotation synchronization member comprises a first pulley having, as its axis of concentricity, the first axis of arm link rotation; the second rotation synchronization member comprises a second pulley having, as its axis of rotation, the second axis of rotation; the first rotation synchronizing coupler comprises a first belt extending between the first and second pulleys; the third rotation synchronization member comprises a third pulley having, as its axis of rotation, the second axis of rotation; the fourth rotation synchronization member comprises a fourth pulley having, as its axis of rotation, the second axis of rotation; and the second rotation synchronization coupler comprises a second belt extending between the third and fourth pulleys.

15. The robotic arm of claim 14, wherein the second pulley and the third pulley rotate in lockstep.

16. The robotic arm of claim 14, wherein the ratio of diameters of the first, second, third and fourth pulleys are: 2:1:1:2 respectively.

17. The robotic arm of claim 14, wherein the ratio of diameters of the first, second, third and fourth pulleys cause linear motion and fixed payload orientation with respect to world coordinates.

18. The robotic arm of claim 13, wherein the robotic arm is driven by a motor.

19. The robotic arm of claim 18, wherein rotation of the motor causes the payload mounting element to travel in a linear path.

20. The robotic arm of claim 18, wherein rotation of the motor causes the payload mounting element to travel in an oscillating linear path.

21. The robotic arm of claim 19, wherein the rotation of the motor is bidirectional.

22. The robotic arm of claim 19, wherein the rotation of the motor is unidirectional.

23. The robotic arm of claim 18, wherein the motor is a programmable servomotor.

24. The robotic arm of claim 14, wherein the ratio of diameters of the first, second, third and fourth pulleys are selected to cause the payload mounting element to travel in a nonlinear path.

25. A robotic arm having a local coordinate system of reference, comprising:
a first rotation synchronization member fixed with respect to the local coordinate system of reference;
a first arm link rotatable relative to the grounded first rotation synchronization member about a first axis of rotation;
a second arm link rotatably mounted to the first arm link, the second arm link rotatable relative to the first arm link about a second axis of rotation;
a second rotation synchronization member provided on the second arm link, the second rotation synchronization member being non-rotatably fixed relative to the second arm link and rotatable relative to the first arm link about the second axis of rotation; and
a rotation synchronizing coupler connecting the first rotation synchronization member to the second rotation synchronization member, the rotation synchronization coupler for driving rotation of the second arm link relative to the first arm link about the second axis of rotation when the first arm link is rotated about the first axis of rotation.

26. A robotic arm, comprising:
a first rotation synchronization member fixed with respect to world coordinates;
a first arm link rotatable relative to the grounded first rotation synchronization member about a first axis of rotation;
a second arm link rotatably mounted to the first arm link, the second arm link rotatable relative to the first arm link about a second axis of rotation;
a second rotation synchronization member provided on the second arm link, the second rotation synchronization member being non-rotatably fixed relative to the second arm link and rotatable relative to the first arm link about the second axis of rotation; and
a rotation synchronizing coupler connecting the first rotation synchronization member to the second rotation synchronization member, the rotation synchronization coupler for driving rotation of the second arm link relative to the first arm link about the second axis of rotation when the first arm link is rotated about the first axis of rotation.
